(19) United States
(12) Patent Application Publication
(10) Pub. No.: US 2011/0005780 A1
(43) Pub. Date: Jan. 13, 2011

(54) FIRE SUPPRESSOR CYLINDERS WITH ENHANCED BUBBLE PRODUCTION

(76) Inventors: Paul Rennie, Bracknell (GB); Robert Pallant, Slough (GB)

Correspondence Address: CARLSON, GASKEY & OLDS, P.C., 400 WEST MAPLE ROAD, SUITE 350, BIRMINGHAM, MI, 48009, US

(21) Appl. No.: 12/551,707

(22) Filed: Sep. 1, 2009

(30) Foreign Application Priority Data
Jul. 10, 2009 (GB) 0912100.5

(51) Int. Cl. A62C 35/00

(52) U.S. Cl. 169/9

(57) ABSTRACT

A fire suppression cylinder includes a valve at an outlet of a canister, and a control for the valve. The canister receives a liquid suppressor agent and a pressurized gas. A feature within a portion of the canister will receive the liquid suppressor agent. The feature increases the formation of gas bubbles within the liquid suppressor agent.

### RELATED APPLICATION

This application claims priority to GB Patent Application No. 0912100.5, which was filed Jul. 10, 2009.

### BACKGROUND OF THE INVENTION

This application relates to a type of fire suppressor wherein a liquid suppressor agent is driven out of a canister by the formation of gas bubbles.

Fire suppressors are known, and include a variety of agents that are discharged toward a fire. One type of high discharge rate fire suppressor uses rapid desorption of a pressurizing agent, which is typically pressurized nitrogen or carbon dioxide, from a volatile liquid agent, to drive the liquid agent out of the suppressor canister.

Typically, a valve is triggered to open, and bubbles of a dissolved gas rapidly form in the agent creating a foaming mixture that expands and discharges from the suppressor canister. The formation of this foam is of critical importance to the effective deployment of the agent.

Recent studies of the phenomenon have indicated that the proportion of agent discharged decreases as the temperature decreases. This is believed to be due to a combination of thermodynamic and kinetic effects. Some gases become less soluble in the liquid agent at low temperatures, but also the rate of bubble formation will change.

In order to grow, the bubbles must overcome a pressure inside the suppressor and also the resistance caused by the surface tension of the liquid, which increases at low temperature. Tests have suggested that the initial formation of bubbles may be the rate-determining step at these low temperatures, particularly for a highly soluble gas.

It is known to provide nucleation sites on a surface to form gas bubbles. One example of a nucleation site is the inclusion of surface imperfections on champagne flutes. Such a site can provide a surface where gas molecules can agglomerate.

However, nucleation sites have not been utilized in fire suppression cylinders.

### SUMMARY OF THE INVENTION

A fire suppression cylinder includes a valve at an outlet of a canister, and a control for the valve. The canister receives a liquid suppressor agent and a pressurized gas. A feature is provided within a portion of the canister that will receive the liquid suppressor agent. The feature increases the formation of gas bubbles within the liquid suppressor agent.

These and other features of the present invention can be best understood from the following specification and drawings, the following of which is a brief description.

### BRIEF DESCRIPTION OF THE DRAWINGS

FIG. 1 shows a first embodiment of the present invention.

FIG. 2 shows a second embodiment of the present invention.

FIG. 3 shows a third embodiment of the present invention.

FIG. 4 shows a fourth embodiment of the present invention.

### DETAILED DESCRIPTION OF THE PREFERRED EMBODIMENT

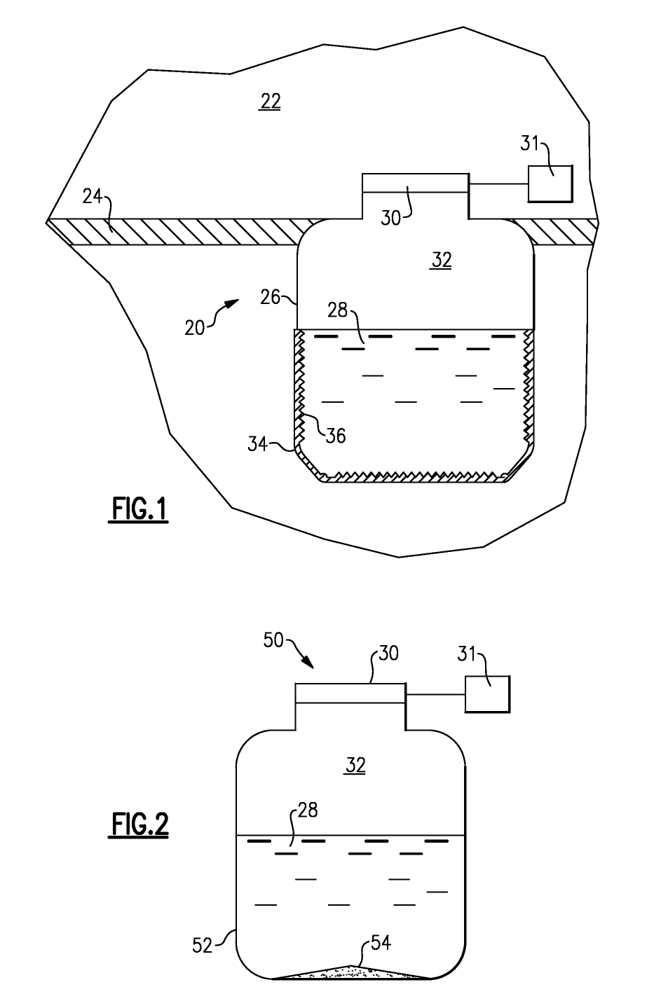

A fire suppression cylinder 20 is illustrated in FIG. 1. Such a module may be included in the wall 24 of a vehicle, such as a ground vehicle or aircraft. An area 22 to be maintained free of fire is associated with the module 20. A valve 30 is selectively controlled by a control 31 to open, and allow an agent to be directed into the area 22. The operation of the valve 30 and the control 31 may be as disclosed in U.S. Patent Application Publication 2006-0016608, the disclosure of which is incorporated by reference. While the fire suppression cylinder is shown with its nozzle extending through wall 24, it may be more common for the cylinder to be mounted in a bracket on an outer side of the wall, with an opening extending through the wall.

The module 20 includes a canister 26 receiving a liquid agent 28, and a gas 32. The agent 28 includes some dissolved gas. A lower portion of the walls 34 of canister 26 is roughened, such as is shown in exaggerated size at 36. The size of the imperfections on the metal wall of the canister 26 is exaggerated as shown at 36 to illustrate the fact of the roughened surfaces. The surfaces may be roughened after formation of the lower portion 34, or roughened as part of their manufacture. The height of the lower portion may correspond to the approximate level of the liquid agent 28. Alternatively, the entire surface of the canister may be roughened.

In embodiments, the roughened portions 36 may stand out at a height of 1 mm or less or, more narrowly, approximately 0.1 mm to 0.5 mm.

FIG. 2 shows another embodiment 50 wherein a canister 52 receives a powder 54 within its liquid suppressor agent 28. The powder is selected such that it does not react with, or dissolve in, the liquid agent 28, and is of a sufficiently fine grain that it will provide a nucleation site, but not interfere with the suppressor otherwise. Examples powders may be silica, alumina, talc, mica, sodium bicarbonate, potassium bicarbonate, and ammonium dihydrogen phosphate.

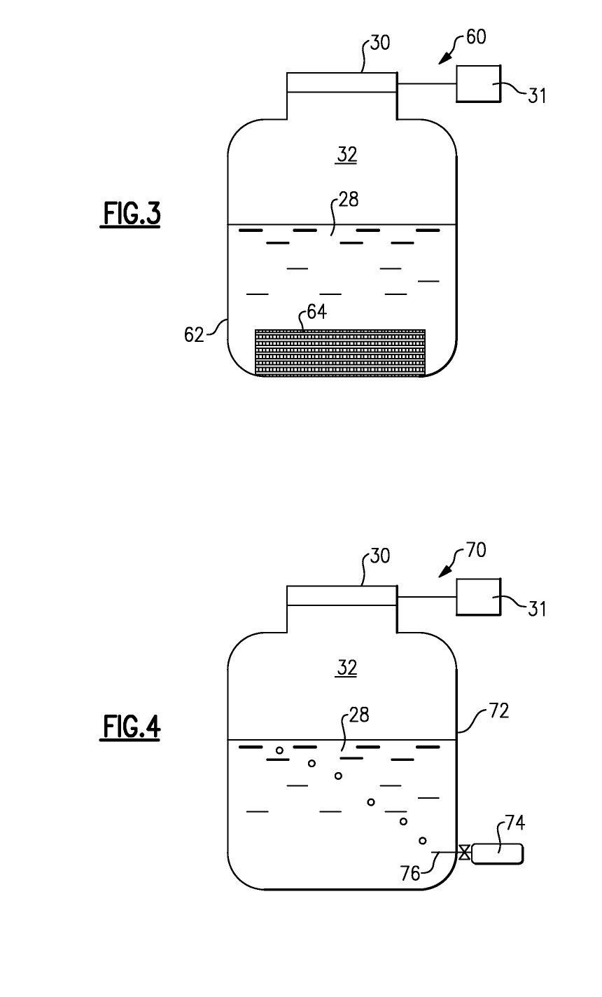

FIG. 3 shows yet another embodiment 60, wherein the canister 62 is provided with an included surface 64. The included surface 64 is selected such that it will not react with the liquid suppressor agent 28. In an illustrated embodiment, a 3-D mesh material is utilized. Again, the 3-D surfaces will provide nucleation sites.

While several embodiments have been shown, another way of forming the roughened surface, in the FIG. 1 embodiment for example, would be to simply attach a rough lining to the inside of the cylinder. In such an embodiment, the material utilized to provide the lining would also preferably be selected such that it would not react with or dissolve in the liquid agent, as is the powder of the FIG. 2 embodiment.

FIG. 4 shows yet another embodiment 70 wherein the canister 72 includes a gas cylinder 74. The gas cylinder 74 communicates with the control 31, such that when the control 31 actuates the valve 30, it also actuates the gas cylinder 74 such that it begins to inject gas bubbles through a pin 76 into the liquid suppressor agent 28.

In sum, four embodiments have been disclosed wherein a feature is provided within the canister that will increase the production of bubbles within the liquid agent. As can be appreciated, the production of the bubbles preferably occurs at discharge, and during operation of the dispensing of the fire suppression materials toward the fire. Bubbles will form without the feature, as in the prior art. The features increase the number and rate of formation of such bubbles. The feature may be roughened surfaces (FIG. 1), a powder (FIG. 2), some included surface (FIG. 3), or actually a system for injecting bubbles (FIG. 4). Of course, these are examples, and other ways of increasing the formation of bubbles may also come within the scope of this invention.

While embodiments of this invention have been disclosed, a worker of ordinary skill in this art would recognize that certain modifications would come within the scope of this invention. For that reason, the following claims should be studied to determine the true scope and content of this invention.

What is claimed is:

1. A fire suppression cylinder comprising:
a valve at an outlet of a canister, and a control for said valve, said canister for receiving a liquid suppressor agent and a pressurized gas; and
a feature within a portion of said canister that will receive the liquid suppressor agent, said feature for increasing the formation of gas bubbles within the liquid suppressor agent.

2. The cylinder as set forth in claim 1, wherein said feature is formed on inner walls of at least a portion of said canister.

3. The cylinder as set forth in claim 2, wherein said feature is formed only at a portion of said inner wall of said canister that will be associated with the approximate level of the liquid suppressor agent.

4. The cylinder as set forth in claim 2, wherein said feature is a roughened surface on said inner wall.

5. The cylinder as set forth in claim 2, wherein a height of said roughened surfaces on said inner wall is less than 1 mm.

6. The cylinder as set forth in claim 5, wherein the height of said roughened surfaces on said inner wall is between 0.1 mm and 0.5 mm.

7. The cylinder as set forth in claim 1, wherein said feature is the inclusion of a powder material within the liquid suppressor agent.

8. The cylinder as set forth in claim 7, wherein said powder may be one of silica, alumina, talc, mica, sodium bicarbonate, potassium bicarbonate, and ammonium dihydrogen phosphate.

9. The cylinder as set forth in claim 1, wherein the feature is a surface that is included within said canister, and which will be submerged in the liquid suppressor agent.

10. The cylinder as set forth in claim 9, wherein said surface is a 3-D material included within the canister.

11. The cylinder as set forth in claim 10, wherein said 3-D material is a mesh.

12. The cylinder as set forth in claim 1, wherein said feature is a gas cylinder that is operable to inject gas bubbles into the liquid suppressor agent when a fire has been identified.
